(19) United States
(12) Patent Application Publication
(10) Pub. No.: US 2004/0215464 A1
(43) Pub. Date: Oct. 28, 2004

(54) Voice activated-automotive window display unit

(76) Inventor: Warren Fred Nelson, St. Paul, MN (US)

Correspondence Address: Warren F. Nelson, P.O. Box 2401, St. Paul, MN, 55102-0401, US

(21) Appl. No.: 10/042,579

(22) Filed: Jan. 9, 2002

(51) Int. Cl. G10L 21/00; G10L 11/00

(52) U.S. Cl. 704/275

(57) ABSTRACT

A voice activated communicating system consisting of an onboard microelectronic computer unit installed in the interior of a vehicle and a light emitting display panel unit located on or in the interior of the vehicle. The VOICE ACTIVATED-AUTOMOTIVE WINDOW DISPLAY UNIT (VA-AWDU) has an electronic connection from the VOICE ACTIVATED-AUTOMOTIVE WINDOW DISPLAY UNIT onboard computer, and an electronic connection from the vehicle's microelectronic main computer. The vehicle operator who's driving the vehicle controls the VA-AWDU computer by voice command. It contains a selection of electronic computerized preprogrammed natural language programs, which displays messages that can be selected by the driver. The driver of the vehicle controls the computerized voice activation, in which transmits the data to the VA-AWDU array display panel. Commands from the manufacturer's vehicle main computer works systematically with the VA-AWDU in regard to current conventional types of signaling devices now equipped on vehicles. Also the unit's digital mode selection console allows the viewer to view multiple standard generic choices of preference all at once. Each generic selection can also be selected by voice activation command. When the selection is made, the message becomes highlighted. The selected command is transmitted directly by electronic circuitry connection to the display panel in the rear of the vehicle by voice command. To disconnect the command, the driver indicates by voice command again wherein the highlighted selection on the VA-AWDU selection indicator console and rear display message disengages.

### BACKGROUND OF THE INVENTION

1. Field of the Invention

The VOICE ACTIVATED-AUTOMOTIVE WINDOW DISPLAY UNIT relates to a digitized information base system installed in the compartment of a vehicle. This invention relates commonly to a communication system installed in a vehicle to communicate intentions to drivers of other vehicles in the rear, or at an angle from the car in front. This invention relates to a interactive system installed in a vehicle in which communicates information concerning situations, and conditions the drivers of other vehicles will encounter. The invention relates to a communication system installed in a vehicle to communicate various other types of information to drivers

2. Discussion of the Related Art

In 1995 there was an estimated total 2,287,000 motor vehicle accidents; in 1996 there was an estimated total of 2,550,000 motor vehicle accidents; and in 1997, there was an estimated total of 3,910,000 rear end motor vehicle accidents. In 1998 there was an estimated total of 3,700,000; in 1999 there was an estimated total of 3,550,000; and in 2000 there was an estimated total of 3,990,000 rear end accidents. (Source: U.S. Department of Transportation Accident facts.)

This device provides broader awareness during operation of motor vehicles. Current conventional rear light signals help, but are not effective, because the average driver has become accustomed, and therefore attention span is relaxed in routine everyday driving. This new technology enhances awareness, and perception, which is needed in reducing angle and rear end collision annual statistics. Interviews with drivers involved in rear end collisions all noted that the reason the collisions occurred, was due to driving too close, not paying attention, or simply didn't notice until too late that the driver in front was slowing or stopping.

Various methods invented for vehicle to vehicle communicating devices have been submitted. Commonly, these devices involved the signaling of pre-selected messages from one vehicle to another by operation of a switch to select the message to be communicated. These methods do not interface with the standard vehicle signaling devices. Communicating devices also include permanent signals with messages that are displayed on the vehicle. Proposed methods include messages that are pre-programmable. System problems occur when these unchanging signals are displayed, and could cause possible conflicts in messages that could represent misinterpret signals, opposite of what user intends to transmit. Confusing messages sent by the device to the drivers of other vehicles when the automatic signals are displayed, pertaining to current conventional signal lights. For example, the driver of a vehicle may be displaying a fixed signal such as merging left lane, when an emergency braking situation occurs. Other methods include using the brakes to transmit information, this is clearly a danger to other drivers in vehicles because brake lights are intended to inform vehicles of slowing and/or stopping, and should remain for just that purpose. In such an instance a driver presses the break pedal and does not have time to remove the current displayed message. These types of devices clearly have real potential to cause accidents.

Another device proposed is a remote control unit pre-programmable by user. This remote device has a table of pre-selected and programmed messages, a rotary switch to scroll through the messages, and a switch to select the desired messages. The rotary device can be pre-programmed by a program installed on a hand held computer with a cable attached from the hand held computer to the remote unit.

The rotary selector switch causes the memory unit to scroll through the selections in the table. As the rotary selector switch points to a message in the table the message is displayed on the driver interface panel. Rotating the rotary selector switch in either direction causes the pattern generating module in the remote control unit to sequence up or down through the pre-set display patterns. To choose the flashing pattern, the rotary selector switch is pushed inwardly, or clicked. Further the remote causes message to scroll if the message is longer than the width of the display unit. And finally, the device has a radio frequency signal encoder and wherein the communication module includes a radio frequency transmitter to transmit an encoded radio frequency signal to the display unit, wherein the communication module to receive the identification code from the remote control unit comprises a radio frequency signal receiver and a radio frequency signal decoder.

In current driving situations, a driver must make clear his or her intentions in a matter of spit seconds. In regards to the rotary device, one must first place the right hand on the rotary selector switch, and turn to sequence up or down through the pre-set display patterns, and search for the desired messages in either direction while still maintaining control of the vehicle. Once message has been located, driver must then push the rotary sector switch inwardly, or clicked, which causes the information concerning the pattern to be sent to the RF sending unit. As stipulated, drivers of vehicles have only spit moments to set forth their intentions to drivers in the rear. To avoid accidents, one must have his/her attention focused on the surrounding traffic, and should not be presented with having to look back and forth from, and to traffic numerous times at a interface panel which only provides one option to be viewed at a time which requires more attention, and thus, placing occupants in possible jeopardy of being involved in a accident. Radio frequency signal represent new technology, but is not a reliable source in this day and age when there are millions of countless imprints of microwave signals bouncing off satellites, and antennas. Radio Frequencies have a tendency to fade, or phase out. Access by users to pre-program what messages are displayed, pose a critical problem, because obscenities can be programmed onto display which could possibly cause road rage, or confusing information by unskilled programmers. Pre-programmed information should be implemented by skilled professionals who have researched, evaluated, and have analyzed all possible driving scenarios which apply to driving situations, Preferably, skilled professionals from a vehicle manufacturer whose main responsibility has already been instituted in providing safety to occupants in their vehicles.

The previous Automotive Digital Rear Window Display Unit system disposed in a vehicle, consists of a solid state microelectronics infrastructure computer unit which is installed in a vehicle, wherein the Automotive Digital Rear Window Display Unit includes a power button which turns the ADRWD power unit on, a light intensity button which provides up to three levels of visual intensity, and depth, a size control button which provides four different size effects, a set of selection function buttons which user has the ability to select the type of display one desires, depending on the driving situation one is surrounded by, a invert rear display button, which changes the background red and the foreground black, or vise versa. The ADRWD Unit has a set of preprogrammed memory program insert chips which translate preprogrammed digital information to the rear display, a activated program chip indicator, which allows user to distinguished which chip is currently in use, a set of program chip selection buttons which selects the type of driving program user wishes activated, a digital mode selection indicator which provides a list of what selections are available on the activated program insert chip, a activated selection highlight indicator function, two standard turning signal buttons which displays an arrow if turning left, or right. A blinking hazard/beacon light button which when pressed it sends a low level electrical current to the display, a stop function button, which stops all commands. The ADRWD interfaces with Mfg.'s automotive microelectronic main computer having a transmittal electronic circuitry signal component processor from which current conventional lighting signals on automobiles are allocated certain degrees of singular sets of precedence over the ADRWD Unit commands.

The ADRWD-Unit technology currently available represents the fastest known reliable source of communicating with drivers of other vehicles at this present time. Pressing one button wherein action engages and disengages commands controls selections.

The existing invention proposes substantially more selections than the earlier ADRWD-Unit with one additional exception that this unit is voice activated, which will allow driver to make selections without having to take one's eyes off the road at a even faster and accurate rate. Both speech recognition systems and natural language systems share a common element in that they both perform better with a larger number of reference patterns (e.g., phonological information or speech templates for voice recognition systems, word and phrase patterns for natural language systems). For natural language systems, the larger the vocabulary of the system, the more flexible and user-friendly the system becomes. For example, it is easier for a person to communicate a message to another person with a vocabulary of one thousand preprogrammed words than three hundred words. Similarly, it is easier to communicate with a computer with a larger vocabulary of commonly understood terms. Furthermore, a larger vocabulary is more likely to accommodate the varied speaking styles and idiosyncrasies of different people. This larger vocabulary also help speech-recognition systems, since a larger vocabulary tends to allow a speaker to construct longer phrases, and the performance of many conventional speech-recognition systems in general tends to improve when multiple words are spoken as compared to short or single words.

The previous existing systems, as well as proposed systems, do not have the capability to provide reliability, accuracy, and increased speed where seconds count.

Henceforth, what is needed is a digitized voice activated communication system that increases the amount of information with accuracy, and spit second speed with pre-programmed digital language memory chips programmed by individuals skilled in the art of highway situations, and scenarios, and most importunately, uncomplicated selections with ample simplicity.

### SUMMARY OF THE INVENTION

The VOICE ACTIVATED-AUTOMOTIVE WINDOW DISPLAY UNIT is a device, which is designed to prevent vehicle rear end, and angle collisions between automobiles. The display unit is installed in or on the windshield of the vehicle. (Properties: voice activated micro electronic computerized control unit, and light emitting display). The Voice Activated-VOICE ACTIVATED-AUTOMOTIVE WINDOW DISPLAY UNIT is a digitized view display operated by microelectronic program language memory chips, which are operated from a computerized control pad within the compartment (car). The purpose of the display is to communicate to vehicles in the rear, the intentions of the driver in front within spit seconds of decision, and selection. The display projects awareness, and alertness to traffic in the rear. The VOICE ACTIVATED-AUTOMOTIVE WINDOW DISPLAY UNIT provides extraordinary advantages. For instance, if a driver was in need of medical help, and unable to drive, in most instances the occupant would have no way to get immediate help from other drivers passing by, unless they tried to flag, stop or use a cell phone. With the VOICE ACTIVATED-AUTOMOTIVE WINDOW DISPLAY UNIT, a near incapacitated driver could communicate the problem, or situation to other drivers, or law enforcement with the voice command emergency program. The VOICE ACTIVATED-AUTOMOTIVE WINDOW DISPLAY UNIT-Control Pad enables user to select text that identifies with the driving situation. It notifies vehicles in the rear, if the driver wishes to switch lanes, merge left, or right traffic lanes, type of passengers on board, speed limit notification to drivers in the rear approaching too fast, driving too close, engine or car trouble, icy road conditions, etc., e.g. The purpose of the current taillight, and conventional turning signal is to communicate to the driver in the rear the intentions of the driver in front of him/her. Unfortunately, they'll not reducing rear end, and angle collisions. The VOICE ACTIVATED-AUTOMOTIVE WINDOW DISPLAY UNIT enhances perception, and observance. Each year the rates of Rear End, and Angle collision fatalities rise.

The design, and concept of the Voice Activated-Automotive Display-Unit is the essential aspect of the device, and is a well-suited new technology for the 21^{st} Century automotive industry.

### BRIEF DESCRIPTION OF THE DRAWINGS

The device facial traits believed nature of the invention are asserted in the attached claims. The invention itself however as well a preferred method of use, and further objects and improvements therefore, will best be comprehend by allusion to the following, specified description of figurative embodiments when read in association with the accompanying drawings, wherein:

FIG. 1 represents a vehicle with a VOICE ACTIVATED-AUTOMOTIVE WINDOW DISPLAY UNIT display in parallelism with the current invention arranged inside the rear window of the vehicle. The display is shown portraying the message “TURNING LEFT. “

FIG. 2 represent a vehicle with a VOICE ACTIVATED-AUTOMOTIVE WINDOW DISPLAY UNIT display in parallelism with the current invention arranged inside the rear window of the vehicle. The display is shown portraying the message “TAXI IN SERVICE.”

FIG. 3 represent a vehicle with a VOICE ACTIVATED-AUTOMOTIVE WINDOW DISPLAY UNIT display in parallelism with the current invention arranged inside the rear window of the vehicle. The display is shown portraying the message “MERGING TRAFFIC.”

FIG. 4 show a VOICE ACTIVATED-AUTOMOTIVE WINDOW DISPLAY UNIT control module system consisting of a solid-state microelectronics infrastructure computer unit in systems check mode.

FIG. 5 show a VOICE ACTIVATED-AUTOMOTIVE WINDOW DISPLAY UNIT control module system consisting of a solid-state microelectronics infrastructure computer unit in power off mode.

FIG. 6 show a VOICE ACTIVATED-AUTOMOTIVE WINDOW DISPLAY UNIT control module system consisting of a solid-state microelectronics infrastructure computer unit in voice on mode, current running selection indicator, current running program indicator.

FIG. 7 show a VOICE ACTIVATED-AUTOMOTIVE WINDOW DISPLAY UNIT control module system consisting of a solid-state microelectronics infrastructure computer unit in voice on mode, current running selection indicator, current running program indicator, activated program console listing.

FIG. 8 show a VOICE ACTIVATED-AUTOMOTIVE WINDOW DISPLAY UNIT control module system consisting of a solid-state microelectronics infrastructure computer unit in voice on mode, current running selection indicator, current running program indicator, activated program console listing, generic option selection listing.

FIG. 9 show a VOICE ACTIVATED-AUTOMOTIVE WINDOW DISPLAY UNIT control module system consisting of a solid-state microelectronics infrastructure computer unit in voice on mode, current running selection indicator, current running program indicator, generic option selection listing.

FIG. 10 show a VOICE ACTIVATED-AUTOMOTIVE WINDOW DISPLAY UNIT control module system consisting of a solid-state microelectronics infrastructure computer unit in which displays a program error message.

FIG. 11 depict how the VA-AWDU display detached from the embodiment to illustrate how the VA-AWDU screen is shaped.

FIG. 12 depict location of the VOICE ACTIVATED-AUTOMOTIVE WINDOW DISPLAY UNIT Control Pad within the compartment of the automobile installed in the steering wheel in systems check mode.

FIG. 13 depict location of the VOICE ACTIVATED-AUTOMOTIVE WINDOW DISPLAY UNIT Control Pad within the compartment of the automobile installed in the steering wheel in power off mode.

FIG. 14 show a block diagram of the VOICE ACTIVATED-AUTOMOTIVE WINDOW DISPLAY UNIT.

### DETAILED DESCRIPTION

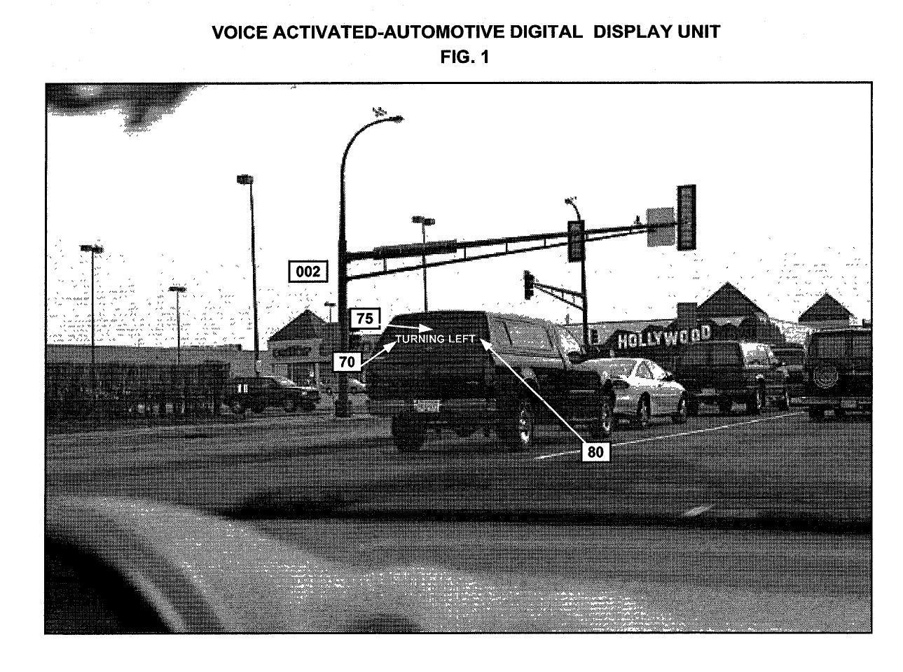

FIG. 1 represent a vehicle with an VOICE ACTIVATED-AUTOMOTIVE WINDOW DISPLAY UNIT display 80 in parallelism with the current invention arranged inside the rear window 75 of the vehicle 002. The display is shown portraying the message “TURNING LEFT” 70. Here the VOICE ACTIVATED-AUTOMOTIVE WINDOW DISPLAY UNIT display indicates to drivers in the rear of the driver's intent to turn left.

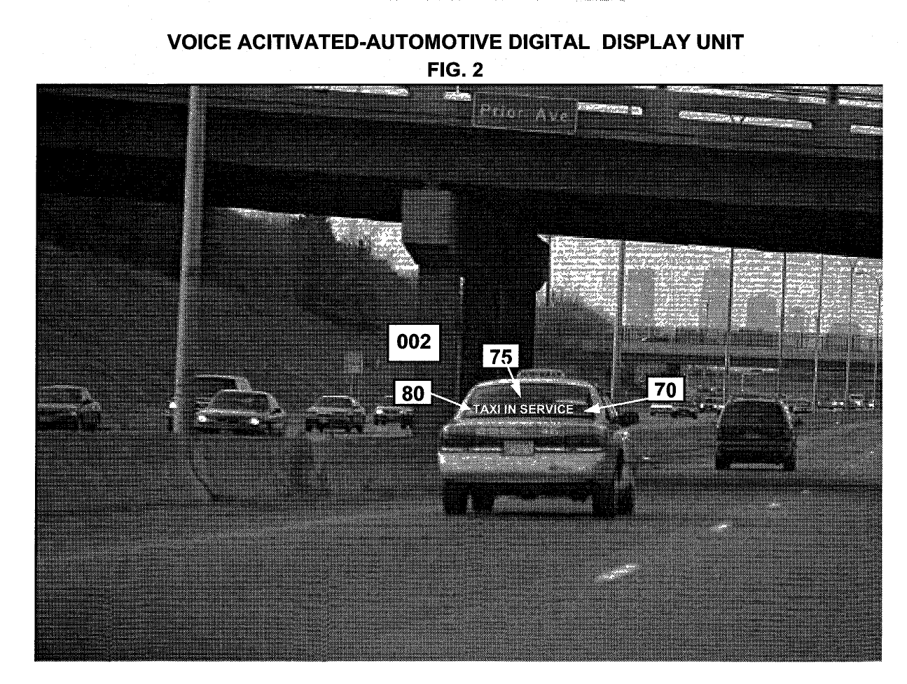

FIG. 2 represent a vehicle with a VOICE ACTIVATED-AUTOMOTIVE WINDOW DISPLAY UNIT display 80 in parallelism with the current invention arranged inside the rear window 75 of the vehicle 002. The display is shown portraying the message “TAXI IN SERVICE” 70. (As symbolized in the illustration, extremely useful for limo services, or airport taxi cabs).

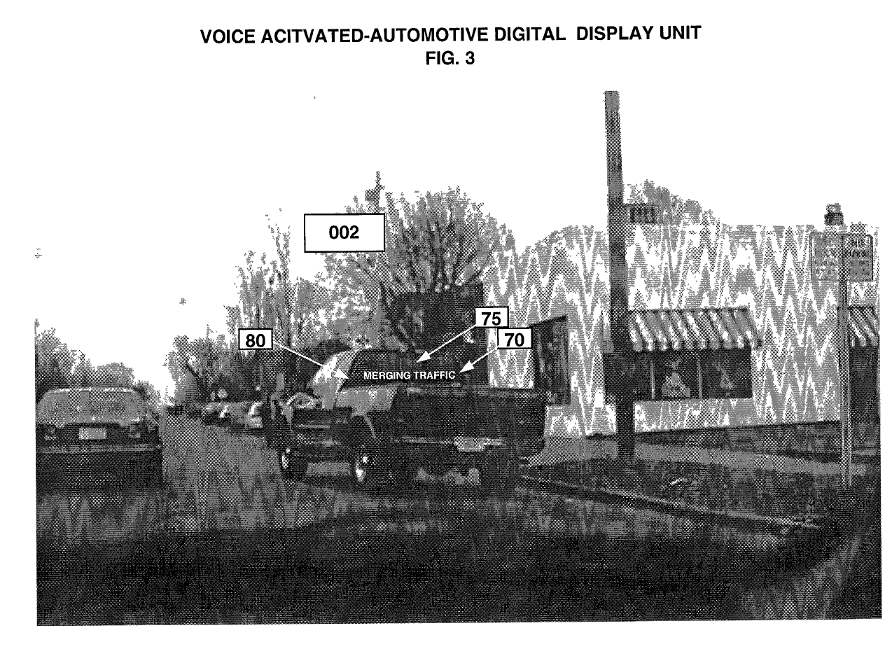

FIG. 3 represent a vehicle with a VOICE ACTIVATED-AUTOMOTIVE WINDOW DISPLAY UN T display 80 in parallelism with the current invention arranged inside the rear window 75 of the vehicle 002. The display is shown portraying the message “MERGING TRAFFIC!” 70.

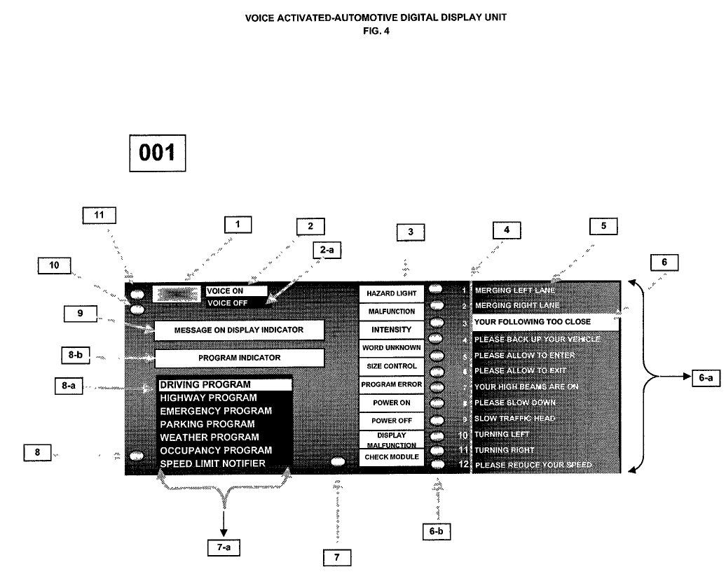

FIG. 4 comprises a VOICE ACTIVATED-AUTOMOTIVE WINDOW DISPLAY UNIT system 001 consisting of a solid state microelectronics infrastructure computer unit in systems check mode which is installed in a vehicle, wherein the VOICE ACTIVATED-AUTOMOTIVE WINDOW DISPLAY UNIT module displays a power button 11, voice microphone 1, voice on indicator 2, voice off indicator 2-a, program signals 3, selection numbered indicator 4, inactivated selection 5, activated selection indicator 6, generic option console 6-a, digital selection buttons for generic selections 6-b, generic selection button initiator 7, program indicator console 7-a, program (list all programs) button 8, activated program selection 8-a, current running program indicator 8-b, current running selection indicator 9, systems check button 10.

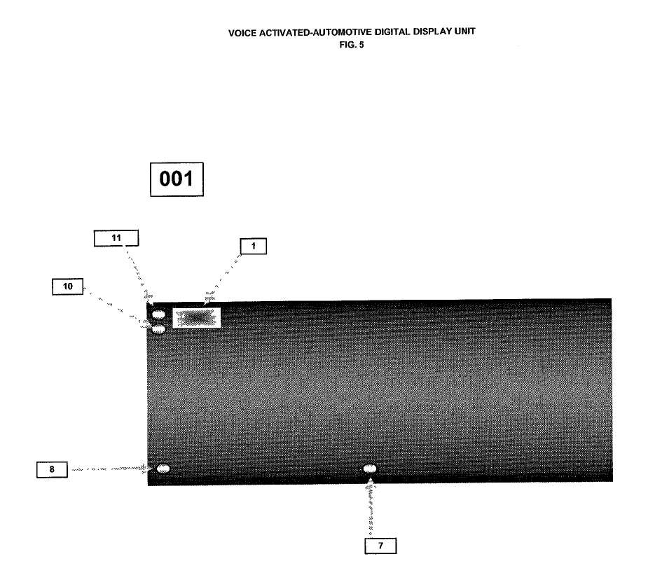

FIG. 5 comprises a VOICE ACTIVATED-AUTOMOTIVE WINDOW DISPLAY UNIT system 001 consisting of a solid state microelectronics infrastructure computer unit in power off mode which is installed in a vehicle, wherein the VOICE ACTIVATED-AUTOMOTIVE WINDOW DISPLAY UNIT module displays a voice microphone 1, generic selection button initiator 7, program (list all programs) button 8, systems check button 10, power button 11.

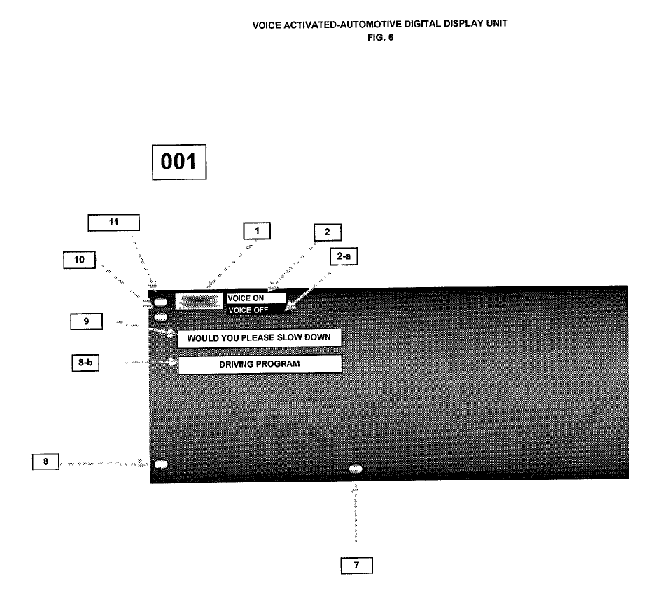

FIG. 6 comprises a VOICE ACTIVATED-AUTOMOTIVE WINDOW DISPLAY UNIT system 001 consisting of a solid state microelectronics infrastructure computer unit power on mode which is installed in a vehicle, wherein the VOICE ACTIVATED-AUTOMOTIVE WINDOW DISPLAY UNIT module displays a voice microphone 1, voice on indicator 2, voice off indicator 2-a, generic selection button initiator 7, program (list all programs) button 8, current running program indicator 8-b, current running selection indicator 9, systems check button 10, power button 11.

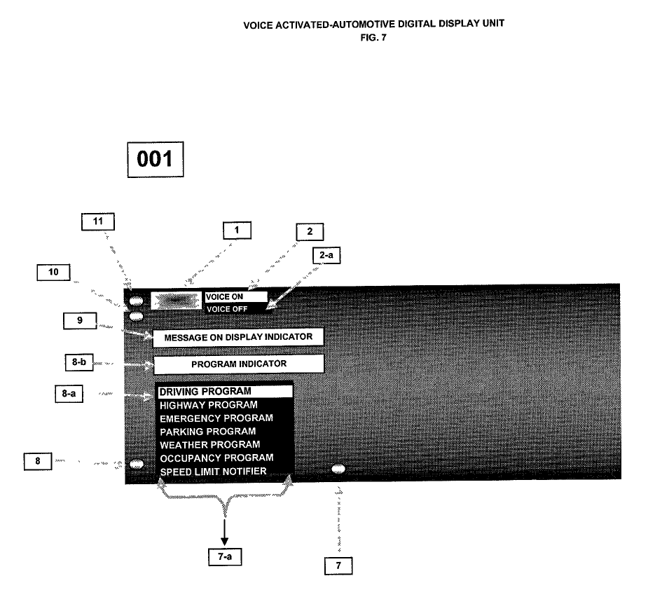

FIG. 7 comprises a VOICE ACTIVATED-AUTOMOTIVE WINDOW DISPLAY UNIT system 001 consisting of a solid state microelectronics infrastructure computer unit where list of programs are activated by the program listing button 8, wherein the VOICE ACTIVATED-AUTOMOTIVE WINDOW DISPLAY UNIT module displays a voice microphone 1, voice on indicator 2, voice off indicator 2-a, generic selection button initiator 7, program indicator console 7-a, program (list all programs) button 8, activated program selection 8-a, current running program indicator 8-b, current running selection indicator 9, systems check button 10, power button 11.

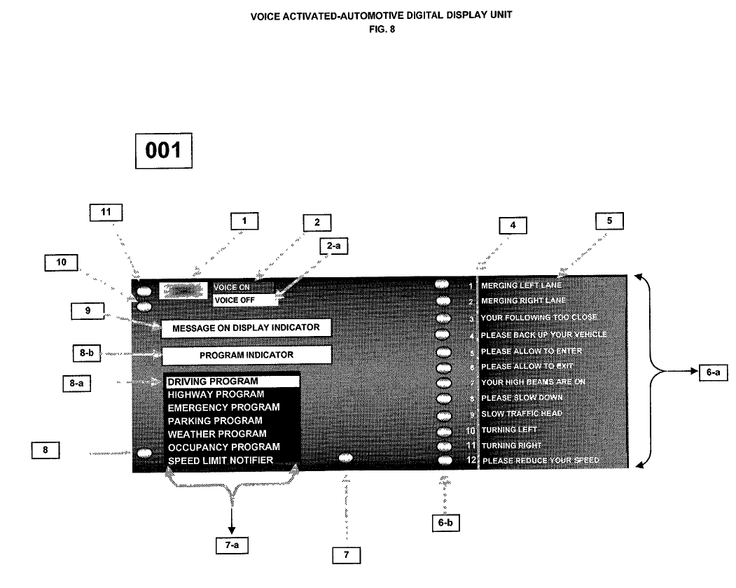

FIG. 8 comprises a VOICE ACTIVATED-AUTOMOTIVE WINDOW DISPLAY UNIT system 001 consisting of a solid state microelectronics infrastructure computer unit installed in a vehicle where a listing of generic selections are activated by the digital selection list button 7, wherein the VOICE ACTIVATED-AUTOMOTIVE WINDOW DISPLAY UNIT module displays a power button 11, voice microphone 1, voice on indicator 2, voice off indicator 2-a, selection numbered indicator 4, inactivated selection 5, generic option console 6-a, digital selection buttons for generic selections 6-b, generic selection button initiator 7, program indicator console 7-a, program (list all programs) button 8, activated program selection 8-a, current running program indicator 8-b, current running selection indicator 9, systems check button 10.

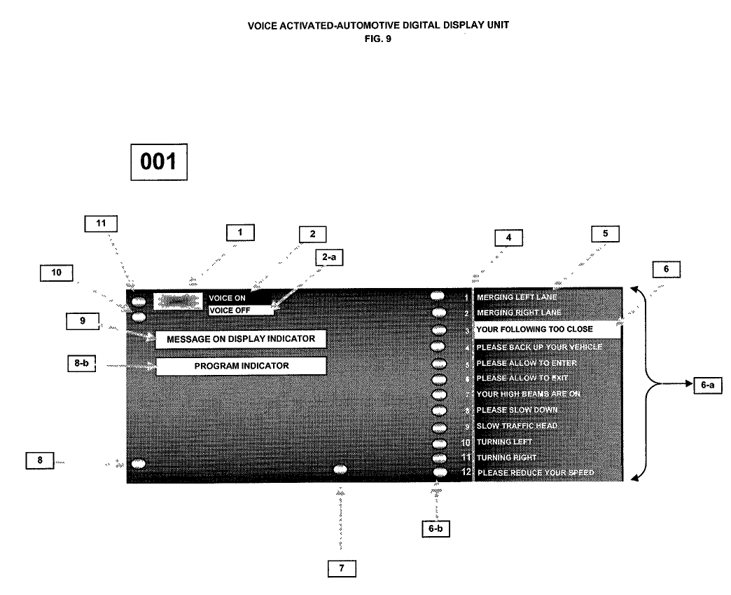

FIG. 9 comprises a VOICE ACTIVATED-AUTOMOTIVE WINDOW DISPLAY UNIT system 001 consisting of a solid state microelectronics infrastructure computer unit installed in a vehicle where a listing of generic selections are activated by the digital selection list button 7, wherein the VOICE ACTIVATED-AUTOMOTIVE WINDOW DISPLAY UNIT module displays a power button 11, voice microphone 1, voice on indicator 2, voice off indicator 2-a, selection numbered indicator 4, inactivated selection 5 activated selection 6, generic selection option console 6-a, digital selection buttons for generic selections 6-b, generic selection button initiator 7, program (list all programs) button 8, current running program indicator 8-b, current running selection indicator 9, systems check button 10.

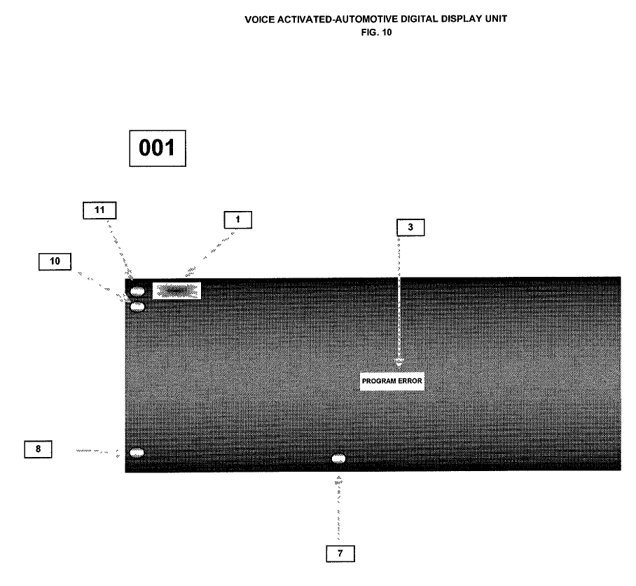

FIG. 10 comprises a VOICE ACTIVATED-AUTOMOTIVE WINDOW DISPLAY UNIT system 001 consisting of a solid state microelectronics infrastructure computer unit installed in a vehicle, wherein the VOICE ACTIVATED-AUTOMOTIVE WINDOW DISPLAY UNIT module displays one out of multiple preprogrammed warning signals 3.

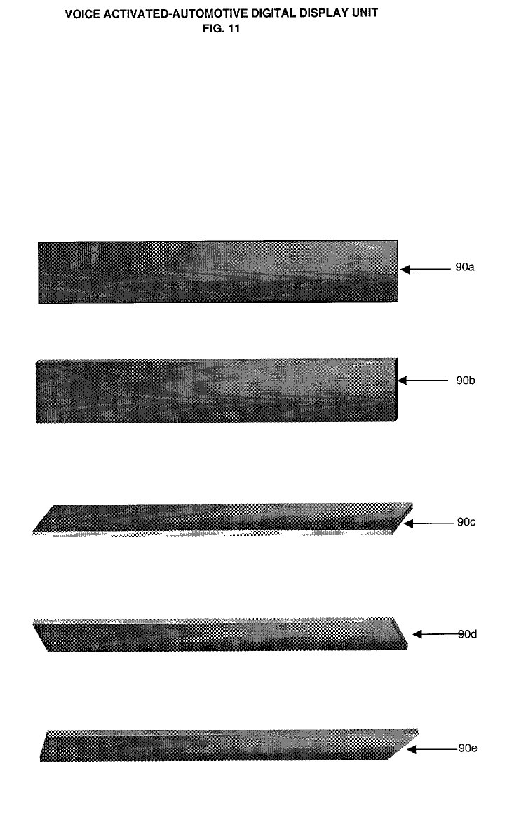

FIG. 11 show a VOICE ACTIVATED-AUTOMOTIVE WINDOW DISPLAY UNIT display from various angles; front 90a, front right 90b, bottom right 90c, top right 90d, top left 90e.

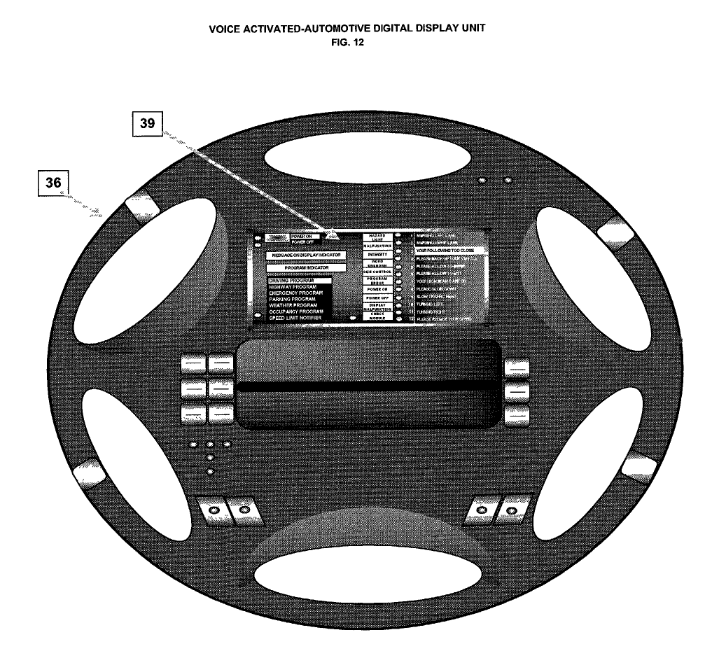

FIG. 12 show the location of the Voice Activated-Automotive Digital Unit control module 39 in systems check mode (see FIG. 4) within the compartment of the automobile consisting of two logical options. One option is to install it into the dashboard. The most preferable option is to install it directly into the steering wheel 36. This option provides maximum performance when voice activated commands are selected. Note: The illustration does not represent the actual size of neither, the steering wheel 36, or VA-AWDU Control Pad 39. The actual size would be similar to standard steering wheel specifications now in circulation for specified automobile models.

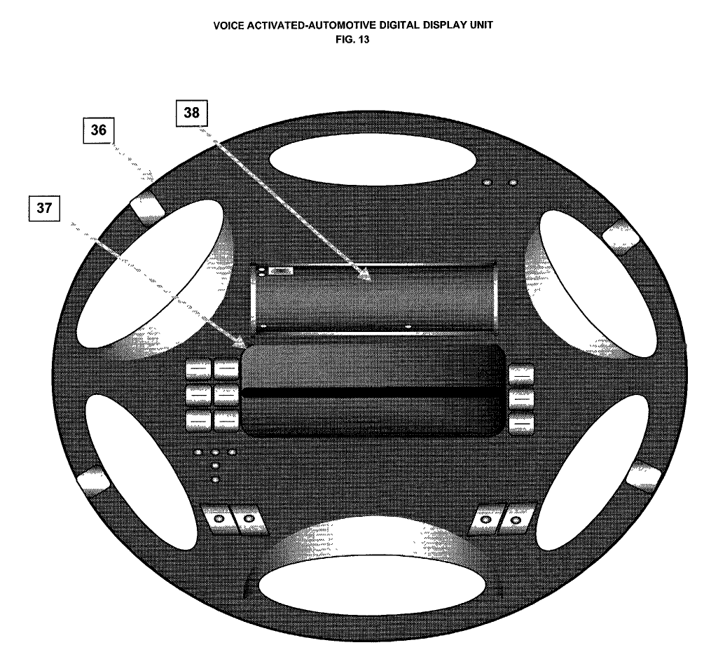

FIG. 13 show the location of the Voice Activated-Automotive Digital Unit control module 38 in power off mode (see FIG. 5) on the steering wheel 36 within the compartment of the automobile consisting of two logical options. Note: The illustration does not represent the actual size of neither, the steering wheel 36, or VA-AWDU-Unit Control Pad 38. The actual size would be similar to standard steering wheel specifications now in circulation for specified automobile models. Further note on FIG. 13 that the VOICE ACTIVATED-AUTOMOTIVE WINDOW DISPLAY UNIT computer module does not interfere with the airbag 37, or maneuverability of the steering wheel 36, but does provide convenience, and easy accessibility in selecting voice activated commands.

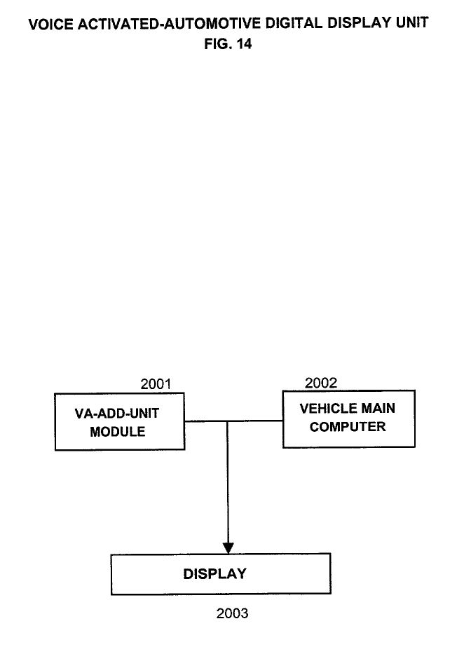

FIG. 14 is a block diagram of the Automotive Window Display Unit 2001 whereas module interfaces with Mfg.'s vehicle microelectronic main computer 2002 having the capability to transmit, and interface by electronic circuitry signal components to the digital light emitting array display panel 2003.

1. A digital component system whereas comprising an VOICE ACTIVATED-AUTOMOTIVE WINDOW DISPLAY UNIT communication system is disposed in or on a vehicle.

2. A digital component system whereas comprising a light emitting display positioned on or inside of the compartment of a vehicle, in which display screen can expand the full length, height, and width of the windshield for optimum distinction, and visualization.

3. A digital component system whereas comprising a display unit which include a micro processing component to acquire the correct priority command method from both the VOICE ACTIVATED-AUTOMOTIVE DIGITAL DISPLAY (VA-AWDU) central processing unit, and the vehicle main micro central processing unit.

4. A digital component system whereas comprising a display which is relayed voice commands from a microelectronic central processing unit through electronically component circuitry connections.

5. A digital component system whereas comprising a automotive main central processing unit having a electronic circuitry signal component processor from which current conventional lighting signals on automobiles are allocated certain degrees of singular sets of precedence over the VOICE ACTIVATED-AUTOMOTIVE WINDOW DISPLAY UNIT commands.

6. A digital component system whereas comprising an VOICE ACTIVATED-AUTOMOTIVE WINDOW DISPLAY UNIT comprises of light emitting display array.

7. A digital component system whereas comprising an VOICE ACTIVATED-AUTOMOTIVE WINDOW DISPLAY UNIT uses direct electronic circuitry connections, and components from the VOICE ACTIVATED-AUTOMOTIVE DISPLAY microelectronic central processing unit to the light emitting display.

8. A digital component system whereas comprising an AUTOMOTIVE WINDOW DISPLAY UNIT-VOICE ACTIVATOR'S function, and design is the exclusive claim of inventor.

9. A digital component system whereas comprising an VOICE ACTIVATED-AUTOMOTIVE WINDOW DISPLAY UNIT has a readable medium whose contents cause a central processing unit system to perform voice-activated connections comprising: the system having a voice-activated connection program and a natural language interface program, by performing the steps of: receiving a request to define said interface by the voice-activated connection program. Receiving a first information item by the voice activated connection program.

10. A digital component system whereas comprising an VOICE ACTIVATED-AUTOMOTIVE WINDOW DISPLAY UNIT comprises speech recognition systems and natural language systems.

11. A digital component system whereas comprising a VA-AWDU in which communicates messages and symbols to the light emitting display through voice-activated commands.

12. A digital component system whereas a driver can send communicated text or symbol message to other drivers through a micro electronic central processing unit in which messages appear on a light emitting display positioned in or on a vehicle by voice activated commands initiated by driver in control of system.

13. A digital component system whereas comprising a voice activated window display unit communication system and is disposed in or on a vehicle.

14. A digital component system whereas VOICE ACTIVATED-AUTOMOTIVE WINDOW DISPLAY UNIT comprises a voice microphone.

15. A digital component system whereas VOICE ACTIVATED-AUTOMOTIVE DISPLAY comprises a voice on indicator.

16. A digital component system whereas VOICE ACTIVATED-AUTOMOTIVE DISPLAY comprises a voice off indicator.

17. A digital component system whereas VOICE ACTIVATED-AUTOMOTIVE DISPLAY comprises a warning light signals.

18. A digital component system whereas VOICE ACTIVATED-AUTOMOTIVE DISPLAY comprises a, selection numbered indicator.

19. A digital component system whereas VOICE ACTIVATED-AUTOMOTTVE DISPLAY comprises an inactivated selections.

20. A digital component system whereas VOICE ACTIVATED-AUTOMOTIVE DISPLAY comprises an activated selection indicator.

21. A digital component system whereas VOICE ACTIVATED-AUTOMOTIVE DISPLAY comprises a generic option selection console.

22. A digital component system whereas VOICE ACTIVATED-AUTOMOTIVE DISPLAY comprises digital selection buttons for generic selections.

23. A digital component system whereas VOICE ACTIVATED-AUTOMOTIVE DISPLAY comprises a generic selection button initiator.

24. A digital component system whereas VOICE ACTIVATED-AUTOMOTIVE DISPLAY comprises a program indicator console.

25. A digital component system whereas VOICE ACTIVATED-AUTOMOTIVE DISPLAY comprises a program (list all programs) button.

26. A digital component system whereas VOICE ACTIVATED-AUTOMOTIVE DISPLAY comprises an activated program selection.

27. A digital component system whereas VOICE ACTIVATED-AUTOMOTIVE DISPLAY comprises a current running program indicator.

28. A digital component system whereas VOICE ACTIVATED-AUTOMOTIVE DISPLAY comprises a current running selection indicator.

29. A digital component system whereas VOICE ACTIVATED-AUTOMOTIVE DISPLAY comprises a systems check button.

30. A digital component system whereas comprising an VOICE ACTIVATED-AUTOMOTIVE WINDOW DISPLAY UNIT a digital component system whereas VOICE ACTIVATED-AUTOMOTIVE DISPLAY comprises a power button.

31. A digital component system whereas comprising an VOICE ACTIVATED-AUTOMOTIVE WINDOW DISPLAY UNIT comprising a voice service system, a voice recognition unit recognizing a user's voice in response to a voice service demand by the user; a server processing information in order to provide the service demanded by the voice recognized user; and a voice synthesis unit converting the information processed by said server into text information to provide the user with the text information.

32. A digital component system whereas comprising an VOICE ACTIVATED-AUTOMOTIVE WINDOW DISPLAY UNIT voice recognition unit comprising a unit identifying a dual tone multi-frequency tone.

33. A digital component system whereas comprising an VOICE ACTIVATED-AUTOMOTIVE WINDOW DISPLAY UNIT comprising a service demand being performed according to one method selected from among a voice menu designation method and a voice searching word input method.

34. A digital component system whereas comprising an VOICE ACTIVATED-AUTOMOTIVE WINDOW DISPLAY UNIT wherein voice recognized user demands, and providing data received from the demanded site to the display after converting the voice into data through said voice synthesis unit.

35. A digital component system whereas comprising an VOICE ACTIVATED-AUTOMOTIVE WINDOW DISPLAY UNIT wherein providing the display preset schedule information for the display after converting the information into data through said voice synthesis unit, when the VA-AWDU demanded service is activated.

36. A digital component system whereas comprising a VOICE ACTIVATED-AUTOMOTIVE WINDOW DISPLAY UNIT wherein comprising: a voice recognition unit recognizing a user's voice when a voice service demand is received from the user, a server accessing information to provide the service demanded by the voice recognized user; and a voice synthesis unit converting the information accessed by said server into data information and conveying the data information to the light emitting display.

37. A digital component system whereas comprising an VOICE ACTIVATED-AUTOMOTIVE WINDOW DISPLAY UNIT wherein the user inputs the demand through VA-AWDU digital electronic connections.

38. A digital component system whereas comprising an VOICE ACTIVATED-AUTOMOTIVE WINDOW DISPLAY UNIT wherein the service demand being performed according to one method selected from among a voice menu designation method and a voice searching word input method.

39. A digital component system whereas comprising a VOICE ACTIVATED-AUTOMOTIVE WINDOW DISPLAY UNIT wherein VA-AWDU connects with display, which the voice recognized user demands, and providing data received from the demanded site to the display after converting the voice into data through said voice synthesis unit.

40. A digital component system whereas comprising a VOICE ACTIVATED-AUTOMOTIVE WINDOW DISPLAY UNIT wherein prior to determining the peak-to-mean likelihood ratio, the method further comprises: determining a short-term averaged energy for the current audio frame; and determining a long-term averaged energy for the current audio frame.

41. A digital component system whereas comprising a VOICE ACTIVATED-AUTOMOTIVE WINDOW DISPLAY UNIT wherein after determining the short-term averaged energy and the long-term averaged energy, the method further comprises: determining whether a sum of the short-term averaged energy and a factor is greater than the long-term averaged energy; and determining that the current audio frame represents silence if the sum is less than the long-term averaged energy, without necessitating a determination of the peak-to-mean likelihood ratio.

42. A digital component system whereas comprising a VOICE ACTIVATED-AUTOMOTIVE WINDOW DISPLAY UNIT wherein the voice activity detector, when executed, controls the processing unit to determine whether a sum of the short-term averaged energy and a predetermined factor is greater than the long-term averaged energy, and to signal that the current audio frame represents silence if the sum is less than the long-term averaged energy.

43. A digital component system whereas comprising a VOICE ACTIVATED-AUTOMOTIVE WINDOW DISPLAY UNIT wherein the voice activity detector, when executed, controls the processing unit to determine a peak-to-mean ratio by (1) sampling an analog signal a predetermined number of times to produce a plurality of sampled signals each having a sampled value, (2) determining a maximum value of the plurality of sampled signals, and (3) conducting a ratio between an absolute value of the maximum value and a summation of the sampled values for the plurality of sampled signals.

44. A digital component system whereas comprising a VOICE ACTIVATED-AUTOMOTIVE WINDOW DISPLAY UNIT wherein the central processing unit program comprising: a first routine for determining a peak-to-mean likelihood ratio; and a second routine for comparing the peak-to-mean likelihood ratio to a selected threshold to determine whether an audio frame being transmitted represents a data signal.

45. A digital component system whereas comprising a VOICE ACTIVATED-AUTOMOTIVE WINDOW DISPLAY UNIT wherein a voice recognition apparatus for recognizing voice within a programmed central processing unit, comprising: a voice data reading means for reading voice data from a voice data recording medium in which the voice data is recorded; a voice recognition means for recognizing voice represented by the voice data and converting it into text data; and a display means for displaying the text data.

46. A digital component system whereas comprising a VOICE ACTIVATED-AUTOMOTIVE WINDOW DISPLAY UNIT comprising a voice recognition apparatus, wherein voice data recorded in said voice data recording medium is compressed digital voice data.

47. A digital component system whereas comprising a VOICE ACTIVATED-AUTOMOTIVE WINDOW DISPLAY UNIT wherein a recording medium having a voice recognition program recorded therein, wherein said voice recognition program causes a central processing unit to: read voice data from a voice data recording medium in which the voice data is recorded; recognize voice represented by the voice data so as to convert it into text data; and display the text data.

48. A digital component system whereas comprising a VOICE ACTIVATED-AUTOMOTIVE WINDOW DISPLAY UNIT wherein a recording medium having a voice recognition program recorded, wherein said voice recognition program further causes the central processing unit to recognize in voice or voice-recognize only a given number of words and convert them into text data at intervals of a given time when causing the central processing unit to recognize voice represented by the voice data and convert it into text data.

49. A digital component system whereas comprising a VOICE ACTIVATED-AUTOMOTIVE WINDOW DISPLAY UNIT wherein a recording medium having a voice recognition program recorded therein, wherein said voice recognition program causes a central processing unit to: read voice data from a voice data recording medium in which the voice data is recorded; recognize voice represented by the voice data so as to detect a given word, and indicate the positions of the given word.

50. A digital component system whereas comprising a VOICE ACTIVATED-AUTOMOTIVE WINDOW DISPLAY UNIT wherein a recording medium having a voice recognition program recorded therein, wherein said voice recognition program causes a central processing unit to: read voice data from a voice data recording medium in which the voice data is recorded; recognize voice represented by the voice data so as to convert it into text data; display the text data; enable designation of the text data using a designation input means; and delete a portion of the voice data corresponding to a portion of the text data designated using said designation input means from said voice data recording medium, and cancel display of the designated portion of the text data.

51. A digital component system whereas comprising a VOICE ACTIVATED-AUTOMOTIVE WINDOW DISPLAY UNIT wherein a recording medium having a voice recognition program recorded therein, said voice recognition program causes a central processing unit to: read voice data from a voice data recording medium in which the voice data is recorded; recognize voice represented by the voice data so as to convert it into text data; acquire position information of positions in said voice data recording medium, at which portions of the voice data corresponding to words of the text data are recorded, in one-to-one correspondence with the words; display the text data; enable designation of at least part of the text data using a designation input means; acquire position information of positions in said voice data recording medium, at which a corresponding portion of the voice data is recorded, according to a word contained in a portion of the text data designated using said designation input means; and delete the corresponding portion of the voice data from said voice data recording medium having the voice data recorded therein on the basis of the position information, and cancel display of the designated portion of the text data.

52. A digital component system whereas comprising a VOICE ACTIVATED-AUTOMOTIVE WINDOW DISPLAY UNIT wherein a voice recognition apparatus, comprising: a voice data reading means for reading voice data from a voice data recording medium in which the voice data is recorded; a detecting means for detecting voice data that is appended to text data and distinguishes an interval within the voice data; a voice recognition means for not recognizing voice represented by a portion of the voice data associated with the given text data, but recognizing voice represented by the other portion of the voice data; and a display means for displaying the result of recognition performed by said voice recognition means.

53. A digital component system whereas comprising a VOICE ACTIVATED-AUTOMOTIVE WINDOW DISPLAY UNIT wherein a voice recognition apparatus, wherein the voice data is recorded by a voice recording apparatus including: a voice data input means for inputting voice data; an interval designating means enabling designation of a desired interval within the voice data input by said voice data input means; a recording means for appending a voice data, which distinguishes the interval designated using said interval designating means, to the voice data and recording the voice data in a voice data recording medium; and a recording medium attaching means for use in freely detachably attaching said voice data recording medium.

54. A digital component system whereas comprising a VOICE ACTIVATED-AUTOMOTIVE WINDOW DISPLAY UNIT wherein a voice recognition apparatus, comprising: a voice data reading means for reading voice data from a voice data recording medium in which the voice data is recorded; a level adjusting means for adjusting the sound level of the voice data read by said voice data reading means according to a given procedure; a voice recognizing means for recognizing voice represented by the voice data whose sound level has been adjusted by said level adjusting means; and a display means for displaying the result of recognition performed by said voice recognizing means.

55. A digital component system whereas comprising a VOICE ACTIVATED-AUTOMOTIVE WINDOW DISPLAY UNIT wherein a voice recognition apparatus, further comprising a minimum value calculating means for calculating a minimum value of an energy level of voice data of a given interval, wherein a criterion of said voice rating means is set on the basis of the minimum value calculated by said minimum value calculating means.

56. A digital component system whereas comprising a VOICE ACTIVATED-AUTOMOTIVE WINDOW DISPLAY UNIT wherein a voice recognition apparatus, comprising: a voice data reading means for reading voice data from a voice data recording medium in which the voice data is recorded; a voice rating means for rating the voice data read by said voice data reading means as voice full portions and voiceless portions; an averaging means for averaging absolute values of voice data items rated as the voice full portions by said voice rating means; a gain calculating means for calculating a gain on the basis of the average value; a multiplying means for multiplying the voice data by the gain; a voice recognizing means for recognizing voice represented by the voice data multiplied by the gain; and a display means for displaying the result of recognition performed by said voice recognizing means.

57. A digital component system whereas comprising a VOICE ACTIVATED-AUTOMOTIVE WINDOW DISPLAY UNIT wherein a recording medium having a voice recognition program recorded therein, wherein said voice recognition program causes a central processing unit (CPU) to: read voice data from a voice data recording medium in which the voice data is recorded; adjust the sound level of the read voice data; recognize voice represented by the voice data whose sound level has been adjusted; and display the result of voice recognition.

58. A digital component system whereas comprising a VOICE ACTIVATED-AUTOMOTIVE WINDOW DISPLAY UNIT wherein a pronunciation recognition apparatus for calculating a score indicating the likelihood of a result of pronunciation recognition applied to an input pronunciation and for recognizing the pronunciation according to the score, comprising: selecting means for selecting one or more words following words which have been obtained in a word string serving as a candidate for a result of the pronunciation recognition, from a group of words to which pronunciation recognition is applied; forming means for calculating the scores for the words selected by the selecting means, and for forming a word string serving as a candidate for a result of the pronunciation recognition according to the scores; storage means for storing word-connection relationships between words in the word string serving as a candidate for a result of the pronunciation recognition; correction means for correcting the word-connection relationships; and determination means for determining a word string serving as the result of the pronunciation recognition according to the corrected word-connection relationships.

59. A digital component system whereas comprising a VOICE ACTIVATED-AUTOMOTIVE WINDOW DISPLAY UNIT wherein the storage means stores nodes, which can be shared as one node.

60. A digital component system whereas comprising a VOICE ACTIVATED-AUTOMOTIVE WINDOW DISPLAY UNIT wherein the storage means stores the acoustic score and the linguistic score of each word, and the starting time and the ending time of the utterance corresponding to each word, together with the connection relationships between words.

61. A digital component system whereas comprising a VOICE ACTIVATED-AUTOMOTIVE WINDOW DISPLAY UNIT wherein a voice recognition apparatus, wherein one of the selecting means, the forming means, and the correction means calculates an acoustic or linguistic score for a word, and performs processing according to the acoustic or linguistic score.

62. A digital component system whereas comprising a VOICE ACTIVATED-AUTOMOTIVE WINDOW DISPLAY UNIT wherein one of the selecting means, the forming means, and the correction means calculates an acoustic or linguistic score for each word independently in terms of time.

63. A digital component system whereas comprising a VOICE ACTIVATED-AUTOMOTIVE WINDOW DISPLAY UNIT wherein a voice recognition method for calculating a score indicating the likelihood of a result of voice recognition applied to an input voice and for recognizing the voice according to the score, comprising: a selecting step of selecting one or more words following words which have been obtained in a word string serving as a candidate for a result of the voice recognition, from a group of words to which voice recognition is applied; a forming step of calculating the scores for the words selected in the selecting step, and of forming a word string serving as a candidate for a result of the voice recognition according to the scores; a correction step of correcting word-connection relationships between words in the word string serving as a candidate for a result of the voice recognition, the word-connection relationships being stored in storage means; and a determination step of determining a word string serving as the result of the voice recognition according to the corrected word-connection relationships.

64. A digital component system whereas comprising a VOICE ACTIVATED-AUTOMOTIVE WINDOW DISPLAY UNIT wherein a recording medium storing a program which makes a central processing unit execute voice-recognition processing for calculating a score indicating the likelihood of a result of voice recognition applied to an input voice and for recognizing the voice according to the score, the program comprising: a selecting step of selecting one or more words following words which have been obtained in a word string serving as a candidate for a result of the voice recognition, from a group of words to which voice recognition is applied; a forming step of calculating the scores for the words selected in the selecting step, and of forming a word string serving as a candidate for a result of the voice recognition according to the scores; a correction step of correcting word-connection relationships between words in the word string serving as a candidate for a result of the voice recognition, the word-connection relationships being stored in storage means; and a determination step of determining a word string serving as the result of the voice recognition according to the corrected word-connection relationships.

65. A digital component system whereas comprising a VOICE ACTIVATED-AUTOMOTIVE WINDOW DISPLAY UNIT wherein said embedded intelligence is a grammar.

66. A digital component system whereas comprising a VOICE ACTIVATED-AUTOMOTIVE WINDOW DISPLAY UNIT wherein said embedded intelligence is a reference to a grammar.

67. A digital component system whereas comprising a VOICE ACTIVATED-AUTOMOTIVE WINDOW DISPLAY UNIT wherein said grammar is dynamically added to a speech recognizer.

68. A digital component system whereas comprising a VOICE ACTIVATED-AUTOMOTIVE WINDOW DISPLAY UNIT wherein said actions come from a speech recognizer.

69. A digital component system whereas comprising a VOICE ACTIVATED-AUTOMOTIVE WINDOW DISPLAY UNIT wherein a means for modifying said grammar and a means for automatically producing an intelligent grammar from said information resource a means for processing said grammar.

70. A digital component system whereas comprising a VOICE ACTIVATED-AUTOMOTIVE WINDOW DISPLAY UNIT wherein said system includes a means for dynamically adding said grammar to a speech recognizer.

71. A digital component system whereas comprising a VOICE ACTIVATED-AUTOMOTIVE WINDOW DISPLAY UNIT wherein said system further includes a means for recognizing sentences from said grammar to follow said information resource.

72. A digital component system whereas comprising a VOICE ACTIVATED-AUTOMOTIVE WINDOW DISPLAY UNIT wherein user interface apparatus for use with a central processing unit which can receive a number of user instructions to reach one of a plurality of possible central processing unit states, wherein said user instructions can be input to said central processing unit using at least natural language as a mode of input, the user interface apparatus comprising: status means for obtaining a current state of said central processing unit; generating means responsive to the obtained current state of said central processing unit to generate information to inform a user of a natural language instruction which can be input to said central processing unit to achieve the current state of said central processing unit; and output means for outputting the generated information to the user.

73. A digital component system whereas comprising a VOICE ACTIVATED-AUTOMOTIVE WINDOW DISPLAY UNIT wherein user interface apparatus, including means for receiving a request from a user of said machine for said information, wherein said generating means is adapted to be responsive to a received request to generate said information.

74. A digital component system whereas comprising a VOICE ACTIVATED-AUTOMOTIVE WINDOW DISPLAY UNIT wherein user interface apparatus, including means for receiving a request from a user, who has input a natural language instruction to arrive at the current state, of said machine for an appropriate natural language instruction to reach the current state, wherein said generating means is adapted to be responsive to a received request to generate said information as the requested instruction.

75. A digital component system whereas comprising a VOICE ACTIVATED-AUTOMOTIVE WINDOW DISPLAY UNIT wherein user interface apparatus, wherein said status means is adapted to maintain a data structure containing attributes defining the current state of the machine, each attribute having a number of possible values.

76. A digital component system whereas comprising a VOICE ACTIVATED-AUTOMOTIVE WINDOW DISPLAY UNIT wherein user interface apparatus, wherein each attribute has at least one natural language fragment associated therewith, and said generating means is adapted to generate said information by building up a natural language instruction from said natural language fragments for said attributes for the current state of said machine.

77. A digital component system whereas comprising a VOICE ACTIVATED-AUTOMOTIVE WINDOW DISPLAY UNIT wherein user interface apparatus, wherein each attribute has at least one natural language fragment associated therewith, and said generating means is adapted to generate said information by building up a natural language instruction from said natural language fragments for said attributes for the current state of said machine.

78. A digital component system whereas comprising a VOICE ACTIVATED-AUTOMOTIVE WINDOW DISPLAY UNIT wherein user interface apparatus, wherein said generating means is adapted to build said natural language instruction in accordance with natural language rules.

79. A digital component system whereas comprising a VOICE ACTIVATED-AUTOMOTIVE WINDOW DISPLAY UNIT wherein user interface apparatus, wherein said generating means is adapted to order said natural language fragments in accordance with order rules.

80. A digital component system whereas comprising a VOICE ACTIVATED-AUTOMOTIVE WINDOW DISPLAY UNIT wherein user interface apparatus, wherein said generating means is adapted to replace elements in the natural language instruction with other elements in dependence upon at least one of previous user interactions, preferred synonyms, user preferences, and natural language input recognition problems.

81. A digital component system whereas comprising a VOICE ACTIVATED-AUTOMOTIVE WINDOW DISPLAY UNIT wherein user interface apparatus, wherein said generating means is adapted to add natural language elements to said natural language instruction as at least one of a natural language prefix and suffix.

82. A digital component system whereas comprising a VOICE ACTIVATED-AUTOMOTIVE WINDOW DISPLAY UNIT wherein user interface apparatus, wherein said generating means is adapted to generate said information as text.

83. A digital component system whereas comprising a VOICE ACTIVATED-AUTOMOTIVE WINDOW DISPLAY UNIT wherein user interface apparatus, wherein said output means includes speech synthesis means for synthesizing speech from said text and audio output means for audibly outputting said speech.

84. A digital component system whereas comprising a VOICE ACTIVATED-AUTOMOTIVE WINDOW DISPLAY UNIT wherein user interface apparatus, wherein said generating means is adapted to generate said information as speech data.

85. A digital component system whereas comprising a VOICE ACTIVATED-AUTOMOTIVE WINDOW DISPLAY UNIT wherein processing apparatus comprising the user interface apparatus according to claim 1 and a machine which can receive a number of user instructions to reach one of a plurality of possible machine states, said machine including instructions input means to input said user instructions to said machine using at least natural language as a mode of input.

86. A digital component system whereas comprising a VOICE ACTIVATED-AUTOMOTIVE WINDOW DISPLAY UNIT wherein a user interface method for use with a machine which can receive a number of user instructions to reach one of a plurality of possible machine states, wherein said user instructions can be input to said machine using at least natural language as a mode of input, the method comprising: obtaining a current state of said machine; generating information to inform a user of natural language instructions which can be input to said machine to achieve the current state of said machine; and outputting the generated information to the user.

87. A digital component system whereas comprising a VOICE ACTIVATED-AUTOMOTIVE WINDOW DISPLAY UNIT wherein a user interface method, including receiving a request from a user of said machine for said information, wherein information is generated in response to said request.

88. A digital component system whereas comprising a VOICE ACTIVATED-AUTOMOTIVE WINDOW DISPLAY UNIT a digital component system whereas comprising a VOICE ACTIVATED-AUTOMOTIVE WINDOW DISPLAY UNIT wherein a user interface method, including receiving a request from a user, who has input a natural language instruction to arrive at the current state, of said machine for an appropriate natural language instruction to reach the current state, wherein said information is generated as the requested instruction in response to said request.

89. A digital component system whereas comprising a VOICE ACTIVATED-AUTOMOTIVE WINDOW DISPLAY UNIT a user interface method wherein the current state of said machine is obtained as a data structure containing attributes defining the current state of the machine, each attribute having a number of possible values.

90. A digital component system whereas comprising a VOICE ACTIVATED-AUTOMOTIVE WINDOW DISPLAY UNIT wherein a user interface method, wherein each attribute has at least one natural language fragment associated therewith and said information is generated by building up a natural language instruction from said natural language fragments for said attributes for the current state of said machine.

91. A digital component system whereas comprising a VOICE ACTIVATED-AUTOMOTIVE WINDOW DISPLAY UNIT wherein a user interface method, wherein said natural language instruction is built in accordance with natural language rules.

92. A digital component system whereas comprising a VOICE ACTIVATED-AUTOMOTIVE WINDOW DISPLAY UNIT a user interface method, wherein said natural language fragments are ordered in said natural language instruction in accordance with order rules.

93. A digital component system whereas comprising a VOICE ACTIVATED-AUTOMOTIVE WINDOW DISPLAY UNIT a user interface method, including replacing elements in the natural language instruction with other elements in dependence upon at least one of previous user interactions, preferred synonyms, user preferences, and natural language input recognition problems.

94. A digital component system whereas comprising an VOICE ACTIVATED-AUTOMOTIVE WINDOW DISPLAY UNIT wherein a user interface method, including adding natural language elements to said natural instruction as at least one of a natural language prefix and suffix.

95. A digital component system whereas comprising an VOICE ACTIVATED-AUTOMOTIVE WINDOW DISPLAY UNIT wherein a user interface method, wherein said information is generated as text.

96. A digital component system whereas comprising a VOICE ACTIVATED-AUTOMOTIVE WINDOW DISPLAY UNIT wherein a user interface method, wherein said text is displayed so as to be output to the user.

97. A digital component system whereas comprising a VOICE ACTIVATED-AUTOMOTIVE WINDOW DISPLAY UNIT wherein a user interface method, including speech data synthesis from said text, wherein said speech data is used to generate audible speech output to the use.

98. A digital component system whereas comprising an VOICE ACTIVATED-AUTOMOTIVE WINDOW DISPLAY UNIT wherein a user interface method, wherein said information is generated as speech data.

99. A digital component system whereas comprising an VOICE ACTIVATED-AUTOMOTIVE WINDOW DISPLAY UNIT program code for controlling a processor to implement the method.

100. A digital component system whereas comprising an VOICE ACTIVATED-AUTOMOTIVE WINDOW DISPLAY UNIT wherein a carrier medium carrying the program code.

101. A digital component system whereas comprising a wherein VOICE ACTIVATED-AUTOMOTIVE WINDOW DISPLAY UNIT wherein speech command from the user that is described within the recognition grammar, a interface system accesses the information source and retrieves the information requested by the user.

102. A digital component system whereas comprising a VOICE ACTIVATED-AUTOMOTIVE WINDOW DISPLAY UNIT wherein a speech recognition engine, a speech synthesis engine, an interactive voice response application, a call processing system, and telephony hardware, and configured to retrieve said instruction set from said database in response to a speech command from said user, said speech command being described in said recognition grammar.

103. A digital component system whereas comprising a VOICE ACTIVATED-AUTOMOTIVE WINDOW DISPLAY UNIT wherein said content descriptor identifying the location of said information to be retrieved for said user; assigning a recognition grammar to said instruction set; storing said instruction set and said recognition grammar on magnetic media in a database; retrieving said instruction set from said database in response to a speech command from said user described in said recognition grammar.

104. A component system whereas comprising a VOICE ACTIVATED-AUTOMOTIVE WINDOW DISPLAY UNIT communication system disposed in or on a vehicle to communicate symbols or text to other drivers of user's intentions pertaining to driving situations.

105. A component system whereas comprising a VOICE ACTIVATED-AUTOMOTIVE WINDOW DISPLAY UNIT located in the vehicle ceiling.

106. A component system whereas comprising a VOICE ACTIVATED-AUTOMOTIVE WINDOW DISPLAY UNIT located in the vehicle steering.

107. A component system whereas comprising a VOICE ACTIVATED-AUTOMOTIVE WINDOW DISPLAY UNIT located in the vehicle dash.

108. A component system whereas comprising a VOICE ACTIVATED-AUTOMOTIVE WINDOW DISPLAY UNIT located in the vehicle visor.
